(19) United States
(12) Patent Application Publication
(10) Pub. No.: US 2008/0075313 A1
(43) Pub. Date: Mar. 27, 2008

(54) ELECTRONIC DEVICE AMD PROCESS FOR MOUNTING MICROPHONE THEREIN

(75) Inventors: Yu-Hsi Lan, Hsinchu County (TW); Kai Xu, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/620,063

(22) Filed: Jan. 5, 2007

(30) Foreign Application Priority Data
Sep. 4, 2006 (TW) 95132574

(51) Int. Cl. H04R 9/08; H04R 19/04; H04R 11/04; H04R 17/02

(52) U.S. Cl. 381/357; 381/356

(57) ABSTRACT

A device comprises a microphone housing and a uni-directional microphone. The microphone housing includes a first acoustic passage and a second acoustic passage. The unidirectional microphone is disposed in the microphone housing, comprising a first surface receiving external sound via the first acoustic passage, and a second surface receiving the external sound via the second acoustic passage, wherein the first acoustic passage runs parallel to the first surface of the unidirectional microphone.

### BACKGROUND OF THE INVENTION

1. Field of the Invention

The invention relates to a device with an internal unidirectional microphone.

2. Description of the Related Art

A unidirectional microphone is capable of clearly receiving sound from a particular direction (typically from the front side of the microphone) and avoiding environmental noise, and thus is often applied in high-quality audio recorders or communications devices.

Most electronic devices (cellular phones, personal digital assistants, and others) have plastic or metal housings which are acoustic isolators. Acoustic isolators block sound waves, increasing the difficulty of microphone placement. Specifically, a unidirectional microphone presenting good performance in open space deteriorates when disposed in a housing of an electronic device, because reception of external sound input blocked by the housing. It is therefore commonly understood that a conventional unidirectional microphone must be always externally connected to an electronic device to achieve adequate quality.

### BRIEF SUMMARY OF THE INVENTION

The invention provides a device comprising an internal unidirectional microphone capable of adequate performance.

The device may comprise a microphone housing and a unidirectional microphone. The microphone housing comprises a first acoustic passage and a second acoustic passage. The unidirectional microphone is disposed in the microphone housing, and comprises a first surface receiving external sound via the first acoustic passage, and a second surface receiving external sound via the second acoustic passage. The first acoustic passage runs parallel to the first surface of the unidirectional microphone.

The second acoustic passage may run parallel to or at an acute angle to the second surface of the unidirectional microphone.

The first surface of the unidirectional microphone may be a front surface.

The second surface of the unidirectional microphone may be a rear surface.

The microphone housing may further comprise an outer surface and a ribbed bumper attached to the outer surface.

The device may further comprise a case with the microphone housing disposed therein and an airtight ring contacting the case. The first acoustic passage comprises a sound inlet enclosed by the airtight ring. The device may further comprise a grill covering the sound inlet.

The device may further comprise a case with the microphone housing disposed therein and an airtight ring contacting the case. The second acoustic passage comprises a sound inlet enclosed by the airtight ring. The device may further comprise a grill covering the sound inlet.

The device may further comprise a case with the microphone housing disposed therein and an airtight protrusion. The airtight protrusion comprises a through hole connected to the first acoustic passage, and the case comprises an opening with the airtight protrusion disposed therein. The airtight protrusion may be circular or rectangular.

The device may further comprise a case with the microphone housing disposed therein and an airtight protrusion. The airtight protrusion comprises a through hole connected to the second acoustic passage. The case comprises an opening with the airtight protrusion disposed therein. The airtight protrusion may be circular or rectangular.

The device may further comprise an omni-directional microphone, wherein the microphone housing further comprises a first storage space connected to the first and second acoustic passages, and a second storage space connected to the first acoustic passage, the unidirectional microphone is disposed in the first storage space, and the omni-directional microphone is disposed in the second storage space.

The microphone housing may further comprise a first part and a second part, the first part comprises a first tenon and a second tenon of different sizes, and the second part comprises a second mortise receiving the first tenon and a second mortise receiving the second tenon.

The microphone housing may further comprise a first part and a second part, the first part comprises a first opening, the second part comprises a second opening, and the first and second openings constitute a first storage space with the unidirectional microphone disposed therein.

The device may further comprise an omni-directional microphone, wherein the first part further comprises a third opening, the second part further comprises a fourth opening. The third and fourth openings constitute a second storage space with the omni-directional microphone disposed therein.

The unidirectional microphone may further comprise electrical wires. The microphone housing further comprises a first part and a second part. The first part comprises a first groove and the second part comprises a second groove. The first and second grooves constitute a channel through which the electrical wires pass.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A-1H depicts various devices containing a unidirectional microphone in accordance with the invention;

FIG. 2A is a perspective diagram of a microphone housing in accordance with an embodiment of the invention;

FIG. 2B is an exploded diagram of the microphone housing of FIG. 2A;

FIG. 2C is a perspective diagram of the microphone housing of FIG. 2A, observed from another direction;

FIG. 2D is an exploded diagram of the microphone housing of FIG. 2C;

FIG. 2E is a sectional view of a first part of the microphone housing of FIG. 2A;

FIG. 2F is a sectional view of a second part of the microphone housing of FIG. 2A;

FIG. 2G is a sectional view of the microphone housing of FIG. 2A, with a uni-directional microphone disposed therein;

FIG. 2H is an exploded diagram of a case and the microphone housing of FIG. 2A;

FIG. 2I depicts the assembly of the case and the microphone housing of FIG. 2H;

FIG. 3A is an exploded diagram of a microphone housing and a grill in accordance with another embodiment of the invention;

FIG. 3B depicts the assembly of the microphone housing and the grill of FIG. 2H;

FIG. 4A is an exploded diagram of a case and a microphone housing in accordance with another embodiment of the invention;

FIG. 4B depicts the assembly of the case and the microphone housing of FIG. 4A;

FIG. 5A is a perspective diagram of a microphone housing in accordance with another embodiment of the invention;

FIG. 5B depicts a assembly of a case and the microphone housing of FIG. 5A;

FIG. 6A depicts a microphone housing before assembly in accordance with another embodiment of the invention;

FIG. 6B is a sectional view of the microphone housing of FIG. 6A along line VIB-VIB;

FIG. 6C is a sectional view of the microphone housing of FIG. 6A along line VIC-VIC;

FIG. 6D is a sectional view of the microphone housing along line VIB-VIB of FIG. 6B after assembly;

FIG. 6E is a sectional view of the microphone housing along line VIB-VIB of FIG. 6C after assembly;

FIG. 7A depicts a microphone housing in accordance with another embodiment of the invention; and

FIG. 7B is a sectional view of the microphone housing of FIG. 7A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

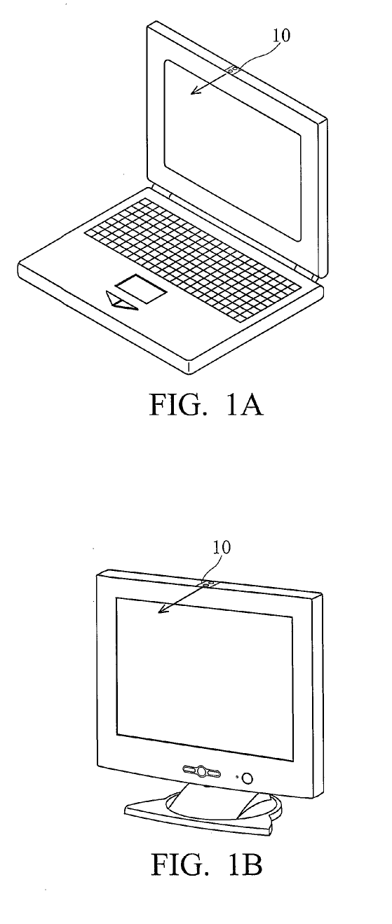

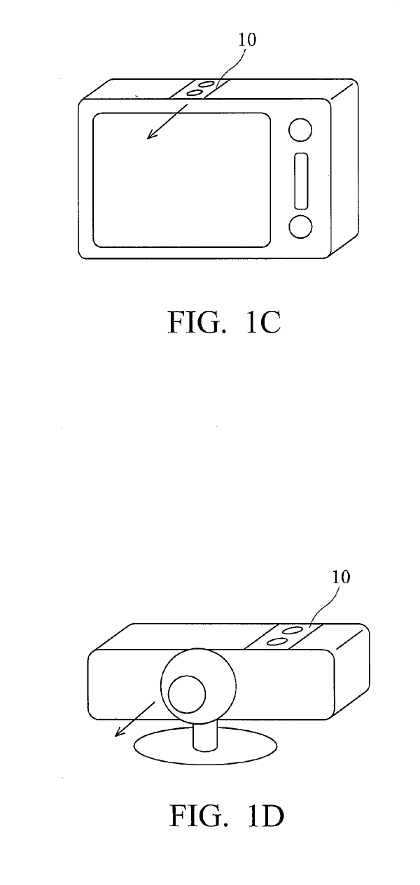

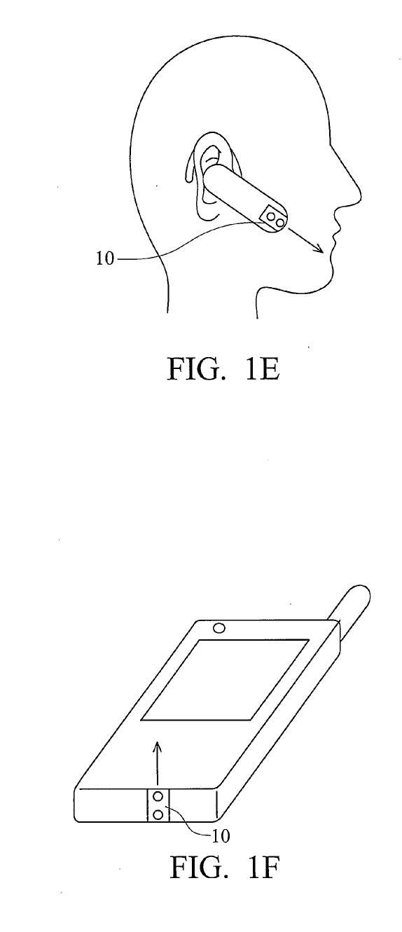

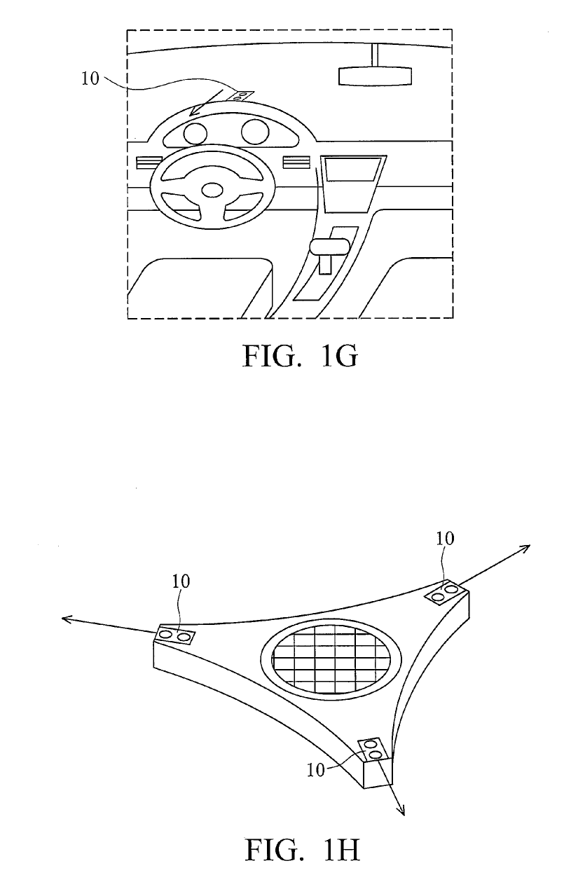

The invention provides a device with an internal unidirectional microphone. The device can be, for example, a notebook computer (FIG. 1A), a liquid crystal display (FIG. 1B), a global positioning system or personal digital assistant (FIG. 1C), a web camera (FIG. 1D), an earphone (FIG. 1E), a cellular phone (FIG. 1F), a car (FIG. 1G), and a speakerphone (FIG. 1H), wherein the direction of the unidirectional microphone 10 is indicated by an arrow.

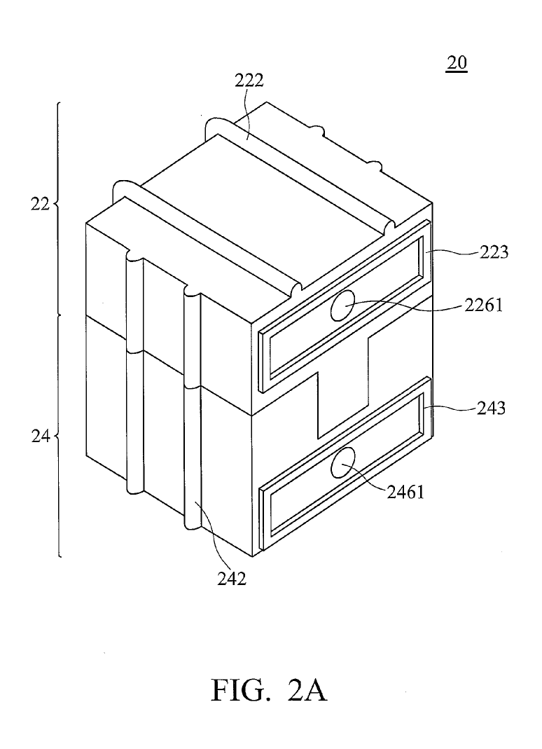

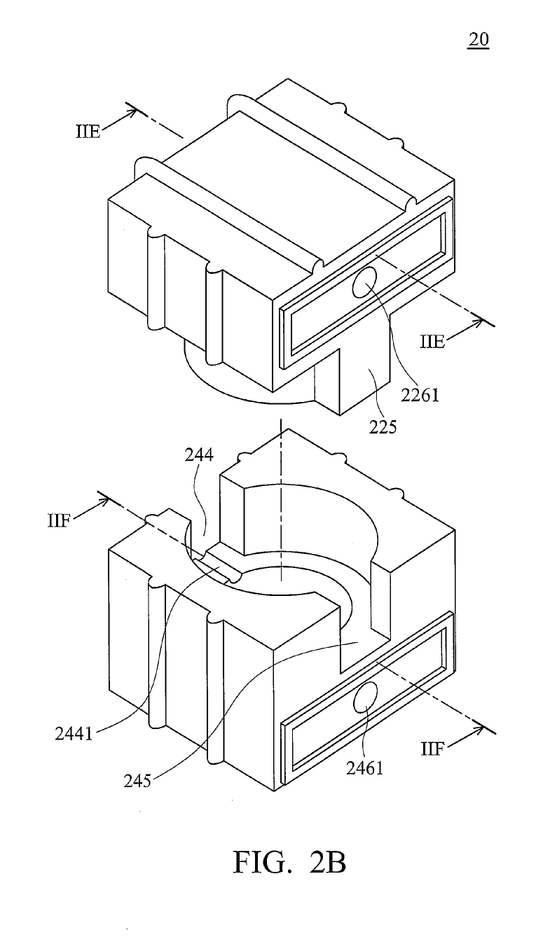

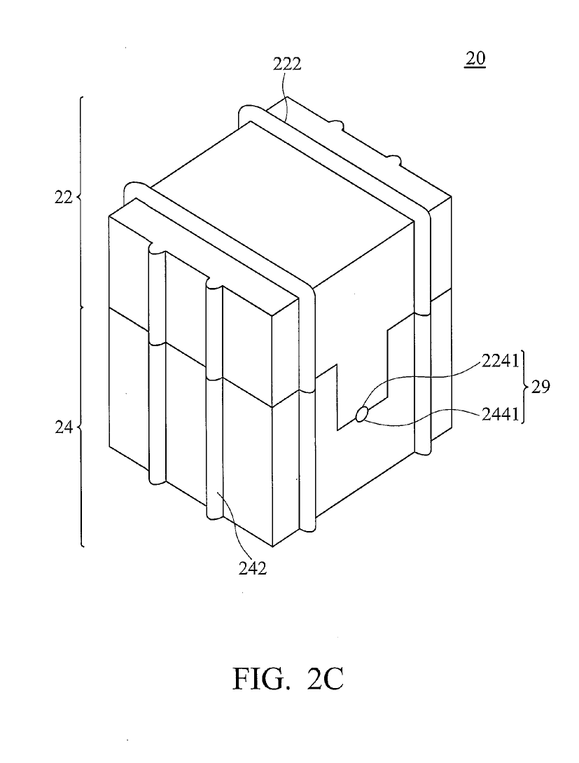

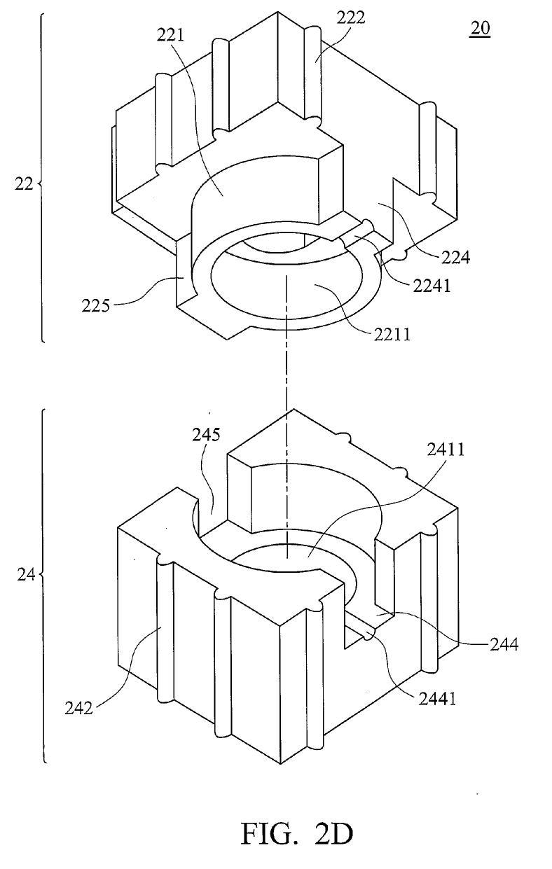

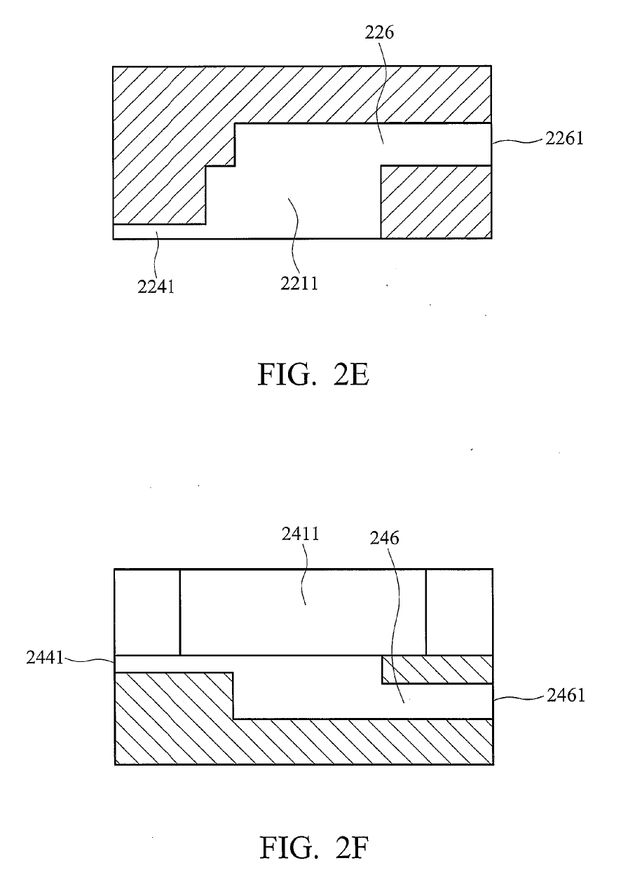

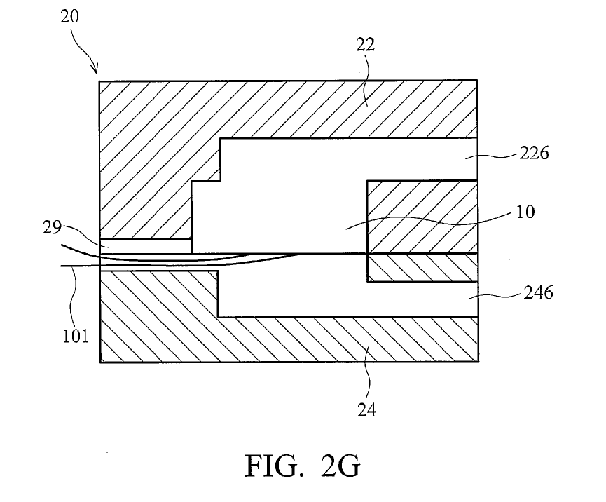

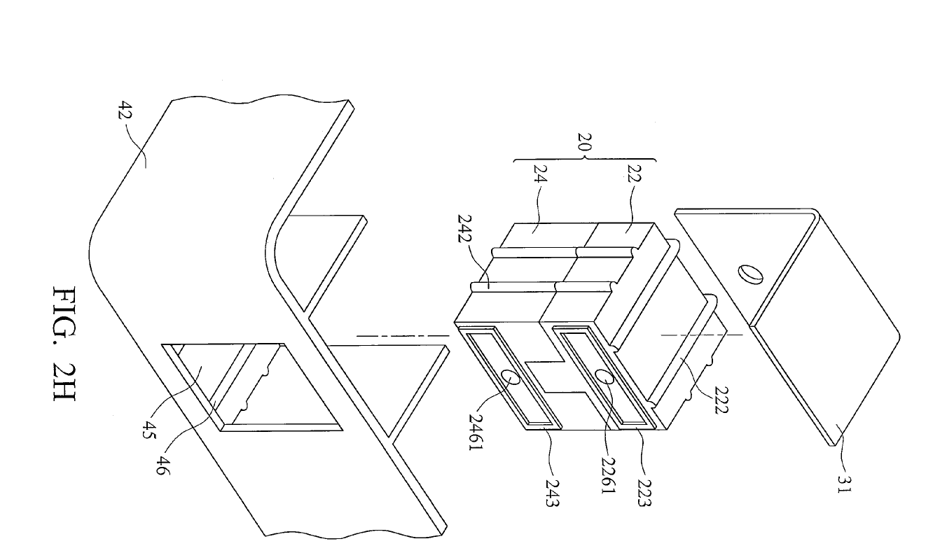

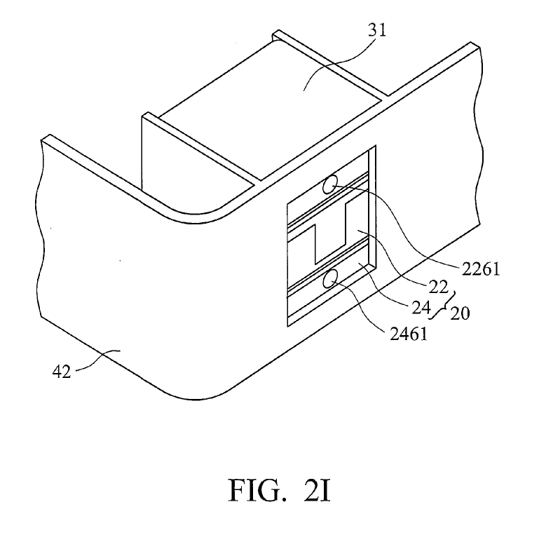

Referring to FIGS. 2A-2F, a microphone housing 20 of an embodiment of the invention comprises a first part 22 and a second part 24.

The first part 22 comprises an airtight ring 223 on its front surface, a plurality of ribbed bumpers 222 on its top, side, and rear surfaces, a microphone holder 221 at its bottom, and a first tenon 224 and a second tenon 225 on opposite sides of the microphone holder 221. The microphone holder 221 has a storage space 221 for receiving a unidirectional microphone. A first groove 2241 is formed on the first tenon 224. A sound inlet 2261 is formed on the front surface of the first part 22 and enclosed by the airtight ring 223. A first acoustic passage 226 is provided in the first part 22 to connect the sound inlet 2261 and the storage space 2211.

The second part 24 comprises an airtight ring 243 on its front surface, a plurality of ribbed bumpers 242 on its bottom, side, and rear surfaces, a receiving space 2411 at its top, and a first mortise 244 and a second mortise 245 on opposite sides of the receiving space 2411. A second groove 2441 is formed in the first mortise 244. A sound inlet 2461 is formed on the front surface of the second part 24 and enclosed by the airtight ring 243. A second acoustic passage 246 is provided in the second part 24 to connect the sound inlet 2461 and the receiving space 2411.

During assembly, a unidirectional microphone is located in the storage space 2211 of the first part 22, and the microphone holder 221 is located in the receiving space 2411 with the first and second tenons 224 and 225 respectively fitted in the first and second mortises 244 and 245. The first groove 2241 and the second groove 2441 constitute a channel 29 for the electrical wires 101 of the unidirectional microphone 10 to pass through, as shown in FIG. 2G. Further referring to FIGS. 2H and 21, the microphone housing 20 is then located in a case 42 of a device and covered by a cover 31. The case 42 has an opening 45 to expose the sound inlets 2261 and 2461 of the microphone housing 20, and grooves 46 for receiving the ribbed bumpers 242 on the bottom of the second part 24. It is understood, however, that the grooves 46 can be cancelled so that the case 42 has a flat inner surface instead and the ribbed bumpers 242 directly contact the flat inner surface of the case 42. The airtight rings 223 and 243 enclosing the sound inlets 2261 and 2461, tightly contact the case 42 to avoid any sound leakage. The ribbed bumpers 222 and 242 attached to the outer surfaces of the microphone housing are used for protecting the uni-directional microphone 10 from vibration.

In operation, the front surface of the unidirectional microphone 10 is capable of receiving external sound via the sound inlet 2261 and the first acoustic passage 226. The rear surface of the unidirectional microphone 10 is capable of receiving external sound via the sound inlet 2461 and the second acoustic passage 246. Note that the first acoustic passage 226 runs parallel to the front surface of the unidirectional microphone 10 to minimize the distance traveled by sound in the microphone housing 20. In such a structural design, the unidirectional microphone in the case 42 of the device still presents good performance and the size of the microphone housing 20 is minimized. In this embodiment, the second acoustic passage 246 runs parallel to the rear surface of the unidirectional microphone 10.

The first and second mortises 244 and 245 match the first and second tenons 224 and 225 in size, respectively. In this embodiment, the first and second tenons 224 and 225 are of different sizes to prevent mistaken reverse assembly. That is, the first tenon 224 is fitted in the second mortise 245 and the second tenon 225 is fitted in the first mortise 244.

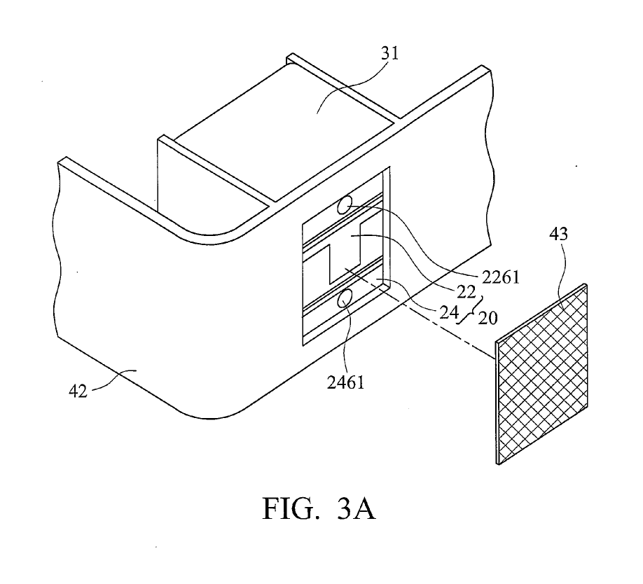

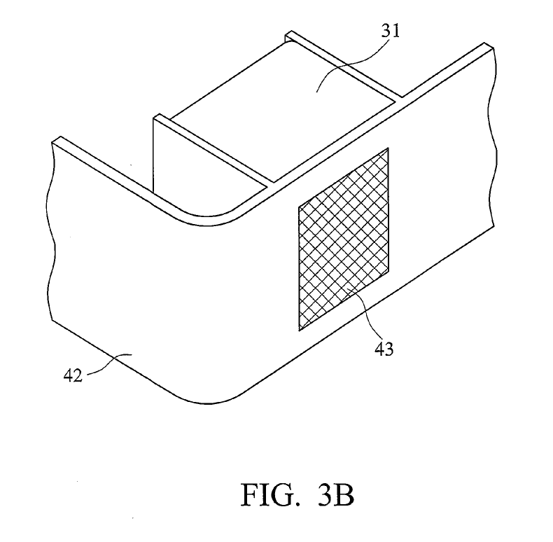

FIGS. 3A and 3B depict another embodiment of the invention, wherein the same references are used for elements which are identical or similar to those of the previous embodiment. The sound inlets 2261 and 2461 are covered by a grill 43 and thus prevent entry of dust.

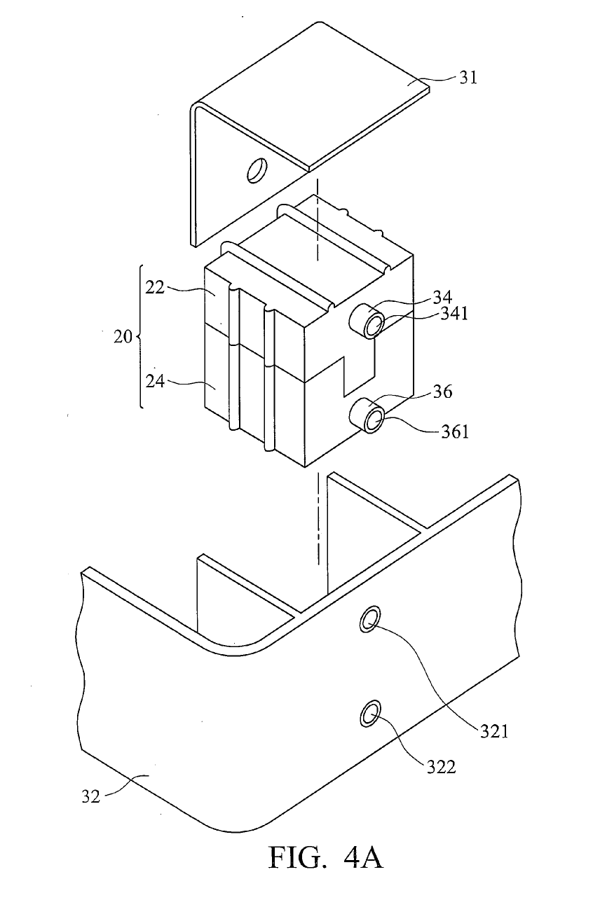

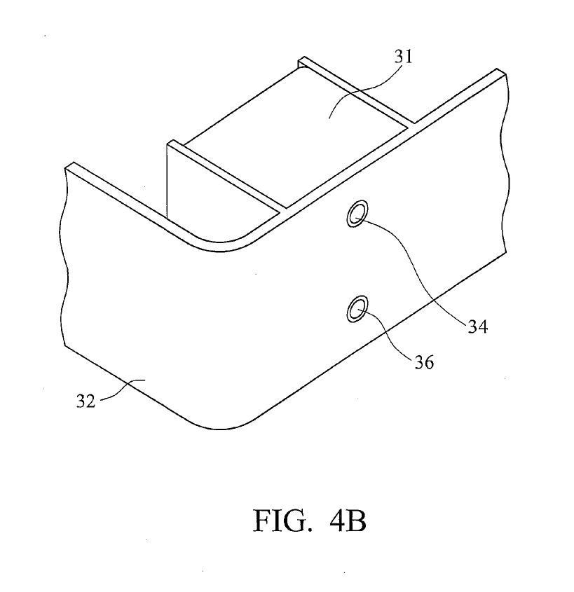

FIGS. 4A and 4B depict another embodiment of the invention, wherein the same references are used for elements which are identical or similar to those of the described embodiments. The case 32 has circular openings 321 and 322. The microphone housing 20 has circular airtight protrusions 34 and 36 respectively disposed in the circular openings 321 and 322 to prevent any sound leakage. The airtight protrusion 34 has a through hole 341 connected to the sound inlet 2261 allowing introduction of external sound into the first acoustic passage 226. The airtight protrusion 36 has a through hole 361 connected to the sound inlet 2461 allowing introduction of external sound into the second acoustic passage 246.

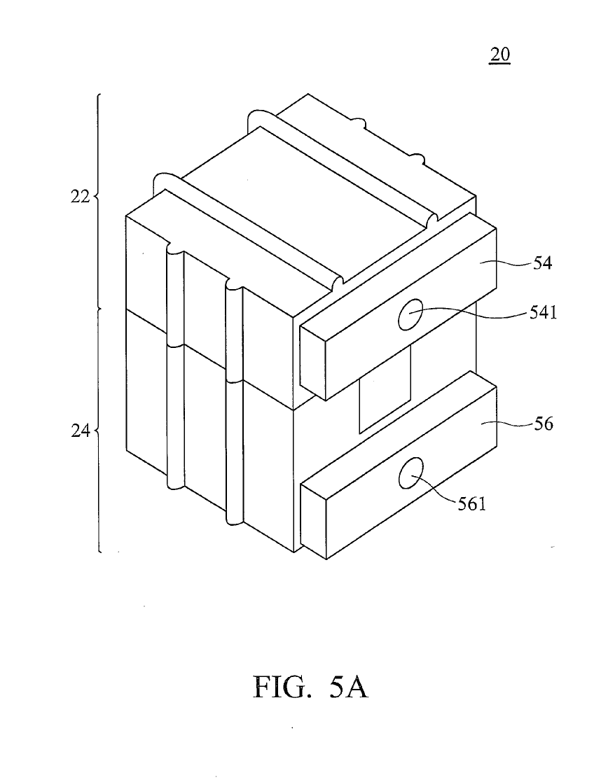

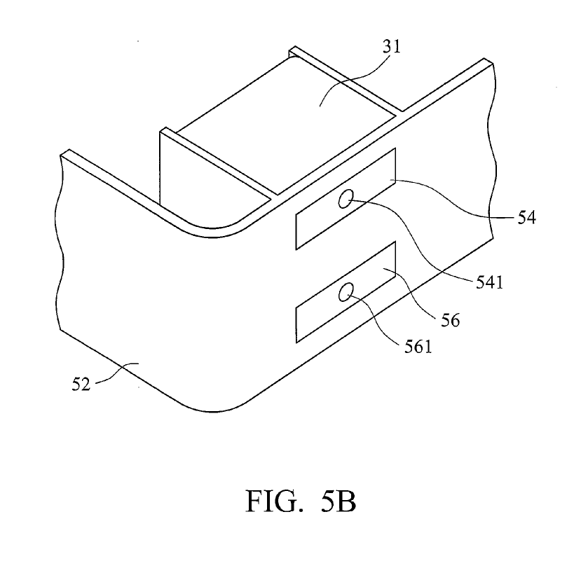

FIGS. 5A and 5B depict another embodiment of the invention, wherein the same references are used for elements which are identical or similar to those of the described embodiments. The microphone housing 20 has rectangular airtight protrusions 54 and 56 respectively disposed in the rectangular openings of the case 52 to prevent any sound leakage. The airtight protrusion 54 has a through hole 541 connected to the sound inlet 2261 for introducing external sound into the first acoustic passage 226. The airtight protrusion 56 has a through hole 561 connected to the sound inlet 2461 for introducing external sound into the second acoustic passage 246.

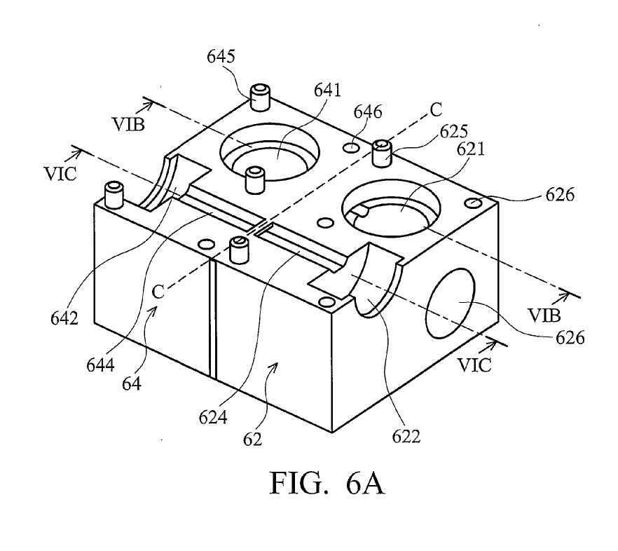

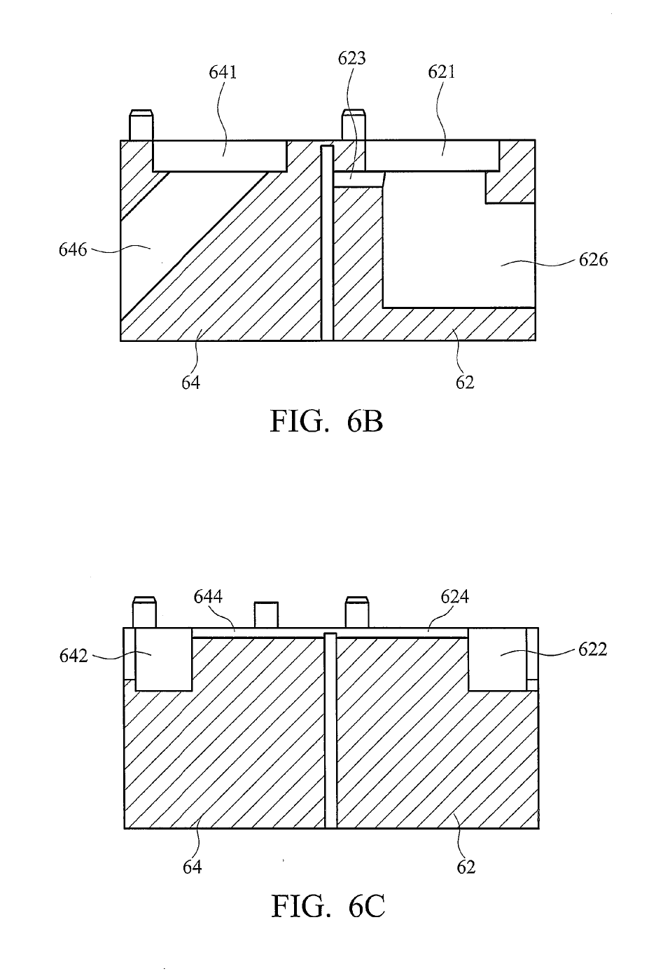

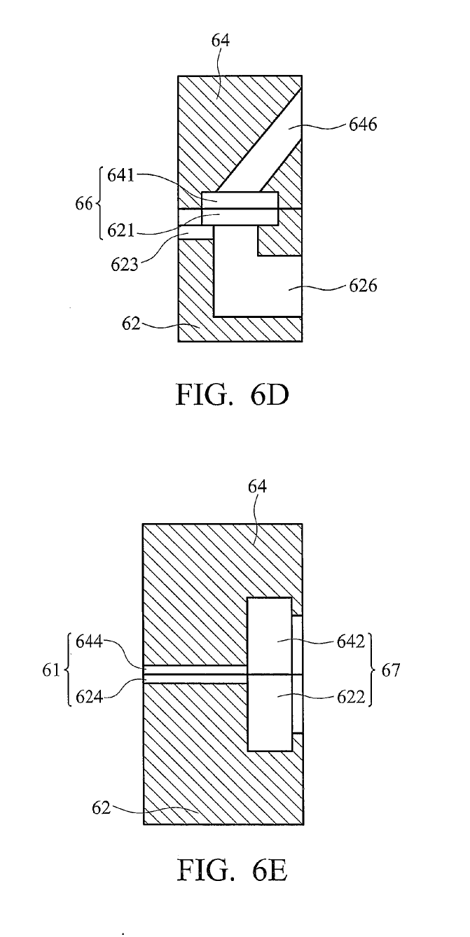

FIGS. 6A-6C depict another embodiment of the invention, wherein the microphone housing is formed by a first part 62 and a second part 64 which are originally connected as a continuous-unity structure. During assembly, the first part 62 and the second part 64 are separated by cutting along line C-C, and the second part 64 is reversed with the top thereof facing downward, and the first and second parts 62 and 64 are joined by fitting the pins 625 of the first part 62 into the holes 646 of the second part 64 as well as fitting the pins 645 of the second part 64 into the holes 626 of the first part 62. As shown in FIG. 6D, a first opening 621 of the first part 62 and a second opening 641 of the second part 64 constitute a first storage space 66 for receiving a unidirectional microphone (not shown). The first part 62 has a channel 623 for the electrical wires of the unidirectional microphone to pass through. Referring to FIG. 6E, a third opening 622 of the first part 62 and a fourth opening 642 of the second part 64 constitute a second storage space 67 for receiving an omni-directional microphone (not shown). A first groove 624 of the first part 62 and a second groove 644 of the second part 64 constitute a channel 61 for the electrical wires of the omni-directional microphone to pass through.

In this embodiment, the first acoustic passage 626 runs parallel to the front surface of the unidirectional microphone (not shown) and the second acoustic passage 646 runs at an acute angle to the rear surface of the unidirectional microphone, when the unidirectional microphone is disposed in the microphone housing. In operation, the unidirectional microphone in the first storage space 66 and the omni-directional microphone in the second storage space 67 constitute a microphone array.

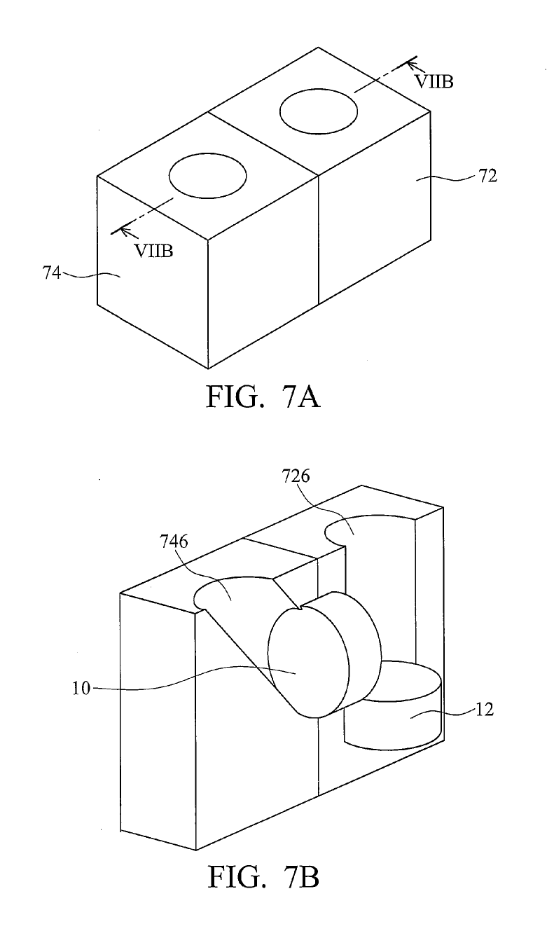

FIGS. 7A and 7B depict another embodiment of the invention, wherein the microphone housing comprises a first part 72, a second part 74, a first acoustic passage 726 in the first part 72, a second acoustic passage 746 in the second part 74, a first storage space connected between the first and second acoustic passage 726 and 746 for receiving a unidirectional microphone 10, a second storage space connected to the first acoustic passage 726 for receiving an omni-directional microphone 12,. The first acoustic passage 726 runs parallel to the front surface of the unidirectional microphone 10. The second acoustic passage 746 runs at an acute angle to the rear surface of the unidirectional microphone 10. The unidirectional microphone 10 in the first storage space and the omni-directional microphone 12 in the second storage space constitute a microphone array. In operation, the uni-directional microphone 10 receives external sound via both the first and second acoustic passages 726 and 746 while the omni-directional microphone 12 receives external sound only via the first acoustic passage 726.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device, comprising:
a microphone housing comprising a first acoustic passage and a second acoustic passage; and
a unidirectional microphone disposed in the microphone housing, comprising a first surface receiving external sound via the first acoustic passage, and a second surface receiving the external sound via the second acoustic passage, wherein the first acoustic passage runs parallel to the first surface of the unidirectional microphone.

2. The device as claimed in claim 1, wherein the second acoustic passage runs parallel to the second surface of the unidirectional microphone.

3. The device as claimed in claim 1, wherein the second acoustic passage runs at an acute angle to the second surface of the unidirectional microphone.

4. The device as claimed in claim 1, wherein the first surface of the uni-directional microphone is a front surface.

5. The device as claimed in claim 1, wherein the second surface of the uni-directional microphone is a rear surface.

6. The device as claimed in claim 1, wherein the microphone housing further comprises an outer surface and a ribbed bumper attached to the outer surface.

7. The device as claimed in claim 1, further comprising a case, wherein the microphone housing is disposed in the case and further comprises an airtight ring contacting the case, and the first acoustic passage comprises a sound inlet enclosed by the airtight ring.

8. The device as claimed in claim 7, further comprising a grill covering the sound inlet.

9. The device as claimed in claim 1, further comprising a case, wherein the microphone housing is disposed in the case and further comprises an airtight ring contacting the case, and the second acoustic passage comprises a sound inlet enclosed by the airtight ring.

10. The device as claimed in claim 9, further comprising a grill covering the sound inlet.

11. The device as claimed in claim 1, further comprising a case, wherein the microphone housing is disposed in the case and further comprises an airtight protrusion, the airtight protrusion comprises a through hole connected to the first acoustic passage, and the case comprises an opening with the airtight protrusion disposed therein.

12. The device as claimed in claim 11, wherein the airtight protrusion is circular.

13. The device as claimed in claim 11, wherein the airtight protrusion is rectangular.

14. The device as claimed in claim 1, further comprising a case, wherein the microphone housing is disposed in the case and further comprises an airtight protrusion, the airtight protrusion comprises a through hole connected to the second acoustic passage, and the case comprises an opening with the airtight protrusion disposed therein.

15. The device as claimed in claim 14, wherein the airtight protrusion is circular.

16. The device as claimed in claim 14, wherein the airtight protrusion is rectangular.

17. The device as claimed in claim 1, further comprising an omni-directional microphone, wherein the microphone housing further comprises a first storage space connected to the first and second acoustic passages, and a second storage space connected to the first acoustic passage, the unidirectional microphone is disposed in the first storage space, and the omni-directional microphone is disposed in the second storage space.

18. The device as claimed in claim 1, wherein the microphone housing further comprises a first part and a second part, the first part comprises a first tenon and a second tenon of different sizes, and the second part comprises a second mortise receiving the first tenon and a second mortise receiving the second tenon.

19. The device as claimed in claim 1, wherein the microphone housing further comprises a first part and a second part, the first part comprises a first opening, the second part comprises a second opening, and the first and second openings constitute a first storage space with the unidirectional microphone disposed therein.

20. The device as claimed in claim 19, further comprising an omni-directional microphone, wherein the first part further comprises a third opening, the second part further comprises a fourth opening, and the third and fourth openings constitute a second storage space with the omni-directional microphone disposed therein.

21. The device as claimed in claim 1, wherein the unidirectional microphone further comprises electrical wires, the microphone housing further comprises a first part and a second part, the first part comprises a first groove, the second part comprises a second groove, and the first and second grooves constitute a channel through which the electrical wires pass.
